(19) United States
(12) Patent Application Publication
(10) Pub. No.: US 2024/0212901 A1
(43) Pub. Date: Jun. 27, 2024

(54) Magnetic Field-Sensitive Component, Production Method, and Use

(71) Applicant: Magnetec GmbH, Hanau (DE)

(72) Inventor: Thomas Wentzlik, Frankfurt Main (DE)

(21) Appl. No.: 18/287,055

(22) PCT Filed: Mar. 23, 2022
(86) PCT No.: PCT/EP2022/057642

§ 371 Date: Oct. 16, 2023

(30) Foreign Application Priority Data
Apr. 16, 2021 (DE) 10 2021 109 597.2

(51) Int. Cl. H01F 1/153; H01F 41/02

(52) U.S. Cl. CPC H01F 1/15308; H01F 1/15333; H01F 41/0246

(57) ABSTRACT

The invention relates to a magnetic field-sensitive component, said magnetic field-sensitive component having particles of a soft magnetic material. In this manner, a magnetic field-sensitive component with a shape that is as flexible as possible can be achieved with a particularly low coercive field strength and a particularly high saturation flux density. By virtue of the design of magnetic field-sensitive component, the effective permeability is reduced and the saturation field strength can thereby be advantageously increased. Overall, a particularly good thermal stability of the magnetic field-sensitive component is thereby produced. The invention additionally relates to a method for producing a magnetic field-sensitive component and to the use of the magnetic field-sensitive component.

The invention relates to a magnetic field-sensitive component, a production method, and a use. In particular, the invention relates to a magnetic field-sensitive component comprising particles of a soft magnetic material, a method for producing a magnetic field-sensitive component using particles of a soft magnetic material and a use of such a magnetic field-sensitive component.

Magnetic field-sensitive components can be characterized by their permeability, their saturation flux density, their saturation field strength, their coercive field strength, and/or their remanence, among others.

In comparison to hard-magnetic components, soft magnetic field-sensitive components have a comparatively high saturation flux density and a comparatively low coercive field strength. Furthermore, soft magnetic field-sensitive components have high permeability compared to hard-magnetic components.

For some applications, soft magnetic field-sensitive components are particularly advantageous, which have a reduced effective permeability, in particular for applications in which a comparatively high saturation field strength is advantageous.

Among other things, the use of magnetic field-sensitive components which have an air gap and/or which have been altered with regard to their material properties with an annealing method is known for such applications cases. In particular, by an air gap, in addition to an increase in the saturation field strength, the permeability can be reduced and the hysteresis curve of the magnetic field-sensitive component can be flattened and linearized, without necessarily influencing the remanence and/or the coercive field strength.

As a result of the material requirements for soft magnetic field-sensitive components, in particular those soft magnetic field-sensitive components with a comparatively high saturation flux density are wound from a very flat strip. This results in a geometric boundary condition for such magnetic field-sensitive components, since only conditional shapes can be produced by winding.

If necessary, an air gap can be introduced after the winding a component by mechanical post-processing of the magnetic field-sensitive component.

The object of the invention is that of providing an improvement over or an alternative to the prior art.

According to a first aspect of the invention, the object is achieved by a magnetic field-sensitive component, said magnetic field-sensitive component having particles of a soft magnetic material.

In this regard, the following is explained conceptually:

It should first be expressly noted that in the context of the present patent application, indefinite articles and numbers such as “one,” “two,” etc. should generally be understood as “at least” statements, i.e. as “at least one . . . ,” “at least two . . . ,” etc., unless it is clear from the relevant context or it is obvious or technically imperative to a person skilled in the art that only “exactly one . . . ,” “exactly two . . . ,” etc. can be meant.

In the context of the present patent application, the expression “in particular” should always be understood as introducing an optional, preferred feature. The expression should not be understood to mean “specifically” or “namely.”

A “magnetic field-sensitive component” is understood to mean a component, in particular a ferromagnetic component, which reacts to a magnetic field by changing at least one state variable of the component. A magnetic field-sensitive component can be used, among other things, together with electrical conductors to produce an inductance that can be used for electrical and/or electronic applications.

Preferably, a magnetic field-sensitive component is understood to mean a component made of a soft magnetic material.

A “magnetically soft material” is understood to mean a material which can easily be magnetized in a magnetic field. Preferably, a soft magnetic material has a coercive field strength of less than or equal to 1,000 A/m.

“Coercive field strength” is understood to mean the magnetic field strength necessary to completely demagnetize a magnetic field-sensitive component previously charged up to saturation flux density.

Preferably, a soft magnetic material, in particular an amorphous soft magnetic material, has an alloy comprising iron, nickel and/or cobalt.

A “particle” is understood to mean a body which is small compared to the magnetic field-sensitive component. Preferably, a particle is understood to mean a body which has an extension in any spatial direction in a range between 3 μm and 200 μm.

Here, a magnetic field-sensitive component comprising particles of a soft magnetic material is proposed.

The magnetic field-sensitive component is thereby preferably primarily shaped by using the particles of the soft magnetic material.

For processing the particles of a soft magnetic material to a magnetic field-sensitive component, a powder metallurgical process is preferably intended, in particular the sintering of a magnetic field-sensitive component from the particles of the soft magnetic material.

Alternatively, however, it should also be considered, inter alia, that the magnetic field-sensitive component may also have a matrix material in addition to the particles of the soft magnetic material. Inter alia, it should be considered here that the particles are dissolved in the matrix material and the matrix material is then cured to form a solid magnetic field-sensitive component. In particular, a matrix material based on a basic component and a curing agent can be used in this case.

It should be expressly noted that all other forming methods are also suitable for producing the magnetic field-sensitive component described here.

Due to the primary forming of the magnetic field-sensitive component using particles of a soft magnetic material, it can be advantageously achieved that virtually any forming is made possible for the magnetic field-sensitive component, whereby it is possible to respond to the specific boundary conditions of the designated application case.

Furthermore, a magnetic field-sensitive component having an air gap can be produced in this way without having to process the magnetic field-sensitive component subsequently by machining, whereby the production of a magnetic field-sensitive component with a reduced effective permeability can be greatly simplified.

According to a particularly expedient embodiment, it should also be considered that by sintering the particles or mixing the particles with a solvent, a magnetic component can be achieved which has pores between the individual particles, wherein the pores can be filled with the surrounding medium or the solvent. The solvent can preferably have a matrix material. The pores cause the magnetic flux between the individual particles to be altered, so that the effective permeability of the magnetic field-sensitive component becomes smaller compared to a magnetic field-sensitive component wound from a soft magnetic material.

In particular for applications in which the thermal stability of the magnetic field-sensitive component plays a dimensioning role, the saturation flux density, the saturation field strength and/or the coercive field strength are dimensioning. The larger the saturation field strength and/or the smaller the coercive field strength and/or the larger the saturation flux density of the magnetic field-sensitive component, the smaller the magnetic field-sensitive component can be for maintaining thermal stability.

A magnetic field-sensitive component is proposed herein, which, due to the material selection of the particles, has a particularly small coercive field strength and a particularly high saturation flux density, whereby by virtue of the design of the magnetic field-sensitive component, the effective permeability is reduced, whereby the saturation field strength can be advantageously increased. In other words, a magnetic field-sensitive component having an advantageous magnetic shear can be achieved.

Furthermore, the magnetic field-sensitive component proposed here advantageously leads to flexible shaping of the magnetic field-sensitive component, which is independent of the boundary condition of the windability of the starting material, whereby the geometry of the magnetic field-sensitive component can be adapted to the boundary conditions of the application case.

Preferably, the magnetic-sensitive component has the particles of the soft magnetic material in a proportion of greater than or equal to 10% by weight, preferably in a proportion of greater than or equal to 20% by weight and particularly preferably in a proportion of greater than or equal to 30% by weight.

Preferably, the magnetic-sensitive component has the particles of the soft magnetic material in a proportion of greater than or equal to 40% by weight, preferably in a proportion of greater than or equal to 50% by weight, and particularly preferably in a proportion of greater than or equal to 60% by weight. Further preferably, the magnetic-sensitive component has the particles of the soft magnetic material in a proportion of greater than or equal to 70% by weight, preferably in a proportion of greater than or equal to 80% by weight, and particularly preferably in a proportion of greater than or equal to 90% by weight. Further preferably, the magnetic-sensitive component has the particles of the soft magnetic material in a proportion of greater than or equal to 95% by weight, preferably in a proportion of greater than or equal to 97.5% by weight, and particularly preferably in a proportion of greater than or equal to 99% by weight.

It should be expressly noted that the above values for the mass fraction of particles of the soft magnetic material are not intended to be understood as sharp limits, but rather are intended to be capable of being exceeded or undercut on an engineering scale without departing from the described aspect of the invention. In simple terms, the values are intended to provide an indication of the size of the mass fraction proposed herein.

Particularly preferably, the magnetic field-sensitive component has a coercive field strength of less than or equal to 10 A/m, preferably a coercive field strength of less than or equal to 5 A/m, and particularly preferably a coercive field strength of less than or equal to 3 A/m.

Preferably, the magnetic field-sensitive component has a coercive field strength of less than or equal to 2 A/m, preferably a coercive field strength of less than or equal to 1.5 A/m, and particularly preferably a coercive field strength of less than or equal to 1 A/m. Further preferably, the magnetic field-sensitive component has a coercive field strength of less than or equal to 0.5 A/m, preferably a coercive field strength of less than or equal to 0.1 A/m, and particularly preferably a coercive field strength of less than or equal to 0.05 A/m.

The above-mentioned values for coercive field strength apply to a magnetic field oscillating at 50 Hz.

A low coercive field strength of the magnetic-sensitive component can reduce dissipation in the magnetic field-sensitive component, in particular in designated application cases with polarity-changing field strengths, which can additionally increase thermal stability.

It shall be expressly noted that the above values for the coercive field strength of the magnetic field-sensitive component are not indented to be understood as sharp limits, but rather are intended to be capable of being exceeded or undercut on an engineering scale without departing from the described aspect of the invention. In simple terms, the values are intended to provide an indication of the magnitude of the coercive field strength of the magnetic field-sensitive component proposed herein.

Particularly expediently, the magnetic field-sensitive component has a remanence of less than or equal to 0.1 T, preferably a remanence of less than or equal to 0.05 T, and particularly preferably a remanence of less than or equal to 0.02 T.

As a result, the dissipation occurring in the magnetic field-sensitive component at polarity-changing field strengths can be additionally advantageously reduced.

Preferably, the magnetic field-sensitive component has a saturation flux density of greater than or equal to 1 T, preferably a saturation flux density of greater than or equal to 1.1 T, and particularly preferably a saturation flux density of greater than or equal to 1.2 T. Preferably, the magnetic field-sensitive component has a magnetic saturation flux density of greater than or equal to 1.3 T.

With increasing saturation flux density, it can be advantageously achieved that the magnetic field-sensitive component can be dimensioned smaller for a reference application case without becoming thermally unstable, in particular since a high saturation field strength can also be achieved along with the high saturation flux density.

It shall be expressly noted that the above values for the magnetic saturation flux density of the magnetic field-sensitive component are not indented to be understood as sharp limits, but rather are intended to be capable of being exceeded or undercut on an engineering scale without departing from the described aspect of the invention. In simple terms, the values are intended to provide an indication of the magnitude of the magnetic saturation flux density of the magnetic field-sensitive component proposed herein.

Optionally, the particles have an extension of less than or equal to 200 μm, in particular an extension in a range of greater than or equal to 3 μm and less than or equal to 200 μm, preferably an extension in a range of greater than or equal to 4 μm and less than or equal to 100 μm, and particularly preferably an extension in a range of greater than or equal to 5 μm and less than or equal to 50 μm.

Further preferably, the particles have an extension in a range of greater than or equal to 7 μm and less than or equal to 40 μm, preferably an extension in a range of greater than or equal to 8 μm and less than or equal to 30 μm, and particularly preferably an extension in a range of greater than or equal to 10 μm and less than or equal to 20 μm.

The size of the particles proposed herein interacts with the resulting pore size between the particles, at least when the magnetic field-sensitive component is produced by means of a sintering method. The pore size in turn interacts with the effective permeability and the latter with thermal stability. During tests, it was found that the above ranges of the particle sizes lead to particularly advantageous magnetic field-sensitive components and/or can be produced particularly easily from the starting material by comminution.

It should be understood that the above range limits can also be combined with each other as desired without departing from this aspect of the invention.

According to a preferred embodiment, the soft magnetic material is a metallic glass. Preferably, the soft magnetic material is a magnetic amorphous metal.

In this regard, the following is explained conceptually:

A “metallic glass” is understood to mean a metal-based alloy of a material which does not have a crystalline but an amorphous structure on an atomic level, and nevertheless has metallic conductivity as a property. Preferably, a metallic glass may also have non-metallic alloy components in addition to metallic alloy components.

The amorphous atomic arrangement, which is very unusual for metals, advantageously allows for particular physical material properties. In particular, by using metallic glasses, the coercive field strength of the magnetic field-sensitive component can be advantageously reduced and/or the permeability can be advantageously increased. In addition, metallic glasses may have a high electrical resistance, as a result of which the eddy current losses caused by the magnetic field-sensitive component can be advantageously reduced for some applications of the magnetic field-sensitive component.

Particularly preferably, the magnetically soft material has a nanocrystalline structure.

In this regard, the following is explained conceptually:

A material with a “nanocrystalline structure” is understood to mean a polycrystalline solid with a nano-microstructure, wherein microstructure is understood to mean the type, crystal structure, number, shape and topological arrangement of point defects, dislocations, stacking errors and crystal boundaries in a crystalline material.

The nanocrystalline structure can further improve the physical properties of the magnetic field-sensitive component. In particular, the permeability of the soft magnetic material can be increased and/or the saturation of the soft magnetic material can be reduced.

Preferably, a nanocrystalline material is produced from an amorphous material, wherein the crystal growth is stimulated starting from the amorphous material by the action of a thermal and/or magnetic action.

Preferably, the magnetic field-sensitive component consists of a soft magnetic material with a nanocrystalline structure having a typical grain size in the range of 5 μm to 30 μm, preferably of a nanocrystalline soft magnetic material with a typical grain size in the range of 7 μm to 20 μm, particularly preferably of a nanocrystalline soft magnetic material with a typical grain size in the range of 8 μm to 15 μm. In this way, particularly advantageous physical properties for the magnetic field-sensitive component can be achieved, in particular with regard to permeability and/or saturation field strength.

According to a particularly preferred embodiment, the soft magnetic material has the following atomic composition:

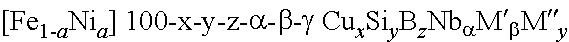

where a≤0.3, 0.6≤x≤1.5, 10≤γ≤17, 5≤z≤14, 2≤α≤6, ß≤7, and γ≤8, wherein M′ is at least one of the elements V, Cr, Al and Zn, wherein M″ is at least one of the elements C, Ge, P, Ga, Sb, In and Be.

Laboratory tests have shown that the above specification of the soft magnetic material results in particularly advantageous material properties for the magnetic field-sensitive component proposed herein.

In particular, the above material specification can be used to achieve a magnetic field-sensitive component with a particularly low coercive field strength and/or a particularly high saturation flux density.

Preferably, the soft magnetic material specified above has nickel, in particular a nickel content of greater than or equal to 4.5% by weight, preferably a nickel content of greater than or equal to 5% by weight, and particularly preferably a nickel content of greater than or equal to 5.5% by weight.

According to an optional embodiment, the magnetic field-sensitive component has a matrix material, in particular a resin-based matrix material.

In this regard, the following is explained conceptually:

A “matrix material” is understood to mean a material in which the particles of the soft magnetic material can be dissolved and which supports the magnetic field-sensitive component in maintaining its physical shape.

Dissolving the particles of the soft magnetic material in the matrix material is understood to mean that the particles, while maintaining their material composition, are or have been converted into a mixture which is largely homogeneous, in the technical sense of that term, and comprises, in addition to the particles, at least one solvent for the particles, in particular at least the matrix material. The idea is for the solvent to surround the particles, and for the particles to be bonded to the solvent by adhesive interactions.

The solvent preferably also has a filler in addition to the matrix material. The price for the magnetic field-sensitive component can thereby be reduced and/or the chemical and/or physical properties of the magnetic field-sensitive component can be improved.

The matrix material is preferably meant to be a liquid material, in particular a liquid material with a dilatant or Newtonian or pseudoplastic or Bingham-plastic or Casson-plastic flow behavior.

According to an optional embodiment, the matrix material is or has been cured after the particles have been dissolved, in particular by a reaction between the matrix material and a curing agent.

It should be expressly noted that magnetic field-sensitive components are also proposed herein whose particles of the soft magnetic material are not in a solid state, but rather dissolved in a liquid solvent. For this embodiment, it is provided that the mixture of solvent and particles are surrounded by a form-defining shell.

Preferably, a magnetic field-sensitive component can be achieved in which there is no need for direct contact between the particles. Thereby, the effective permeability of the magnetic field-sensitive component can additionally be reduced. The pore size or generally the distance between the individual particles of the soft magnetic substance can advantageously be set by the mixing ratio of the particles of the soft magnetic substance to the solvent, whereby in particular the effective permeability of the magnetic field-sensitive component can be set.

According to a particularly expedient embodiment, the magnetic field-sensitive component is sintered.

In this regard, the following is explained conceptually:

“Sintering” is understood to mean a method for producing or altering a magnetic field-sensitive component. In this process, the particles of the soft magnetic material are heated, but the temperatures remain below the melting temperature of the particles of the soft magnetic material, so that the shape of the magnetic field-sensitive component is retained. During sintering, shrinkage of the dimensions of the magnetic field-sensitive component can occur because the particles of the soft magnetic material densify and pore spaces are filled. Preferably, the particles of the soft magnetic material are compressed before tempering and/or during tempering. By sintering the particles, a material bond between the particles is achieved.

Advantageously, by means of a sintered magnetic field-sensitive component, it can be achieved that the effective permeability corresponds particularly precisely to the desired value.

Sintered magnetic field-sensitive components are advantageously robust and are dimensionally stable even at operating temperatures between 200° C. and 350° C. Overall, sintered magnetic field-sensitive components exhibit a particularly high thermal stability.

According to a second aspect of the invention, the object achieves a method for producing a magnetic field-sensitive component using particles of a soft magnetic material, characterized by the following steps:
forming a blank for the magnetic field-sensitive component using the particles of the soft magnetic material;
tempering and/or curing in order to solidify the blank into the magnetic field-sensitive component; and
demolding of the magnetic field-sensitive component.

In this regard, the following is explained conceptually:

In the context of this embodiment, “forming” is understood to mean the forming into a blank for the magnetic field-sensitive component.

Preferably, a blank consisting of particles of a soft magnetic material can be formed in a sintering tool, the sintering tool serving as a negative mold.

Preferably, other forming methods should also be considered when forming.

In particular, the introduction of a mixture comprising a solvent, preferably a matrix material, and particles of the soft magnetic material into a negative mold is also considered. In the further course, it should be considered that the mixture in the negative mold can be cured and then demolded as a magnetic field-sensitive component.

Furthermore, it should be considered to fill a mixture comprising a solvent and particles of the soft magnetic substance into a sealable shell, which also creates a magnetic field-sensitive component. In this case, a temperature treatment for solidifying the magnetic field-sensitive component and demolding is not necessary.

A “blank” is understood to mean a formed material which is provided for further treatment, in particular for further treatment by a temperature treatment or a chemical reaction. Preferably, a blank for a sintering process or a blank of a magnetic field-sensitive component should be considered, which is provided for curing by a chemical reaction. In other words, a formed blank is solidified in a downstream further treatment step.

“Tempering” is understood to mean a heat treatment of the blank or of the magnetic field-sensitive component, in particular by a chemical reaction of the components and/or by an external heat source.

“Curing” is understood to mean a chemical reaction of the blank or of the magnetic field-sensitive component, wherein the chemical reaction, in particular a crosslinking reaction, leads to an increase in the hardness and/or the toughness and/or the melting point and/or to a decrease of the solubility of the blank or of the magnetic field-sensitive component.

“Demolding” is understood to mean the removal of the magnetic field-sensitive component from a negative mold.

Herein, method for producing a magnetic field-sensitive component is proposed, in particular for producing a magnetic field-sensitive component according to the first aspect of the invention.

In the prior art, it has hitherto been known that magnetic field-sensitive components are limited with regard to their shape by the boundary conditions originating from the known production methods. This disadvantage in the prior art can be overcome by the production method presented herein, since the method proposed herein enables almost any forming for a magnetic field-sensitive component, in particular for a magnetic field-sensitive component having an air gap.

It is understood that the advantages of a magnetic field-sensitive component, as described above, extend to the method for producing a magnetic field-sensitive component.

Particularly preferably, the magnetic field-sensitive component is sintered.

It is proposed herein that the tempering of the blank is carried out by means of a sintering method.

As a result, the particles made of a soft magnetic material can advantageously be solidified to form a magnetic field-sensitive component.

Expediently, the blank is pressed between forming and sintering and/or during sintering by applying an external force.

By applying the external force before and/or during sintering, the blank and/or the magnetic field-sensitive component can be compacted.

In laboratory tests it was found that a pressing power in a range of greater than or equal to 120 N/mm² and less than or equal to 300 N/mm² is particularly advantageous, preferably a pressing power in a range of greater than or equal to 150 N/mm² and less than or equal to 250 N/mm², and particularly preferably a pressing power in a range of greater than or equal to 180 N/mm² and less than or equal to 200 N/mm².

Advantageously, particularly robust sintered magnetic field-sensitive components can be achieved in this way.

It shall be expressly noted that the above values for the pressing power are not indented to be understood as sharp limits, but rather are intended to be capable of being exceeded or undercut on an engineering scale without departing from the described aspect of the invention. In simple terms, the values are intended to provide an indication of the size of the pressing power proposed herein.

Preferably, the magnetic field-sensitive component is sintered at a temperature in a range of greater than or equal to 400° C. and less than or equal to 650° C., preferably at a temperature in a range of greater than or equal to 450° C. and less than or equal to 620° C., and particularly preferably at a temperature in a range of greater than or equal to 500° C. and less than or equal to 600° C.

With the above-specified values for the temperature during sintering, particularly advantageous magnetic field-sensitive components could be achieved in laboratory tests. In particular, with the indicated values for the temperature, the time and/or the pressing power during the sintering process could be reduced.

Furthermore, it is preferably proposed not to sinter the magnetic field-sensitive component at a temperature above 700° C., preferably not at a temperature above 650° C., and particularly preferably not at a temperature above 600° C., since this can advantageously achieve that a change in the crystal structure of the soft magnetic material can be prevented, in particular a crystallization starting from the amorphous state can be prevented. Preferably, this allows the impedance of the magnetic field-sensitive component to be maintained, as a result of which the thermal stability of the magnetic field-sensitive component can also be maintained.

Preferably, it is proposed not to sinter the magnetic field-sensitive component at a temperature below 400° C., preferably not at a temperature below 550° C., and particularly preferably not at a temperature below 600° C., since this necessitates a higher pressing power during sintering, which, inter alia, increases the tool costs.

Further preferably, the magnetic field-sensitive component is sintered over a time range of greater than or equal to 15 seconds and less than or equal to 1,800 seconds, preferably over a time range of greater than or equal to 30 sec and less than or equal to 900 sec, and particularly preferably over a time range of greater than or equal to 45 sec and less than or equal to 600 sec.

In particular, it is proposed to sinter a magnetic field-sensitive component at 600° C. over a time range of greater than or equal to 15 seconds and less than or equal to 180 seconds, preferably over a time range of greater than or equal to 20 sec and less than or equal to 60 sec.

Preferably, it is further proposed to sinter a magnetic field-sensitive component at 500° C. over a time range of greater than or equal to 500 seconds and less than or equal to 1500 seconds, preferably over a time range of greater than or equal to 750 seconds and less than or equal to 1100 seconds.

It shall be expressly noted that the above values for the temperature and/or sintering time are not indented to be understood as sharp limits, but rather are intended to be capable of being exceeded or undercut on an engineering scale without departing from the described aspect of the invention. In simple terms, the values are intended to provide an indication of the magnitude of the temperature or sintering time proposed herein.

According to an optional embodiment, in addition to particles of the soft magnetic material, a matrix material is also used to form the blank, in particular a resin-based matrix material.

Here, it should be considered to dissolve the particles made of a soft magnetic material in a solvent, preferably in a matrix material. Together with the matrix material, the particles can then be molded into a blank or a magnetic field-sensitive component.

Optionally, curing is carried out by a chemical reaction of the matrix material.

It is proposed here to additionally add a curing agent to the matrix material and the particles of the soft magnetic material. The substance combination of matrix material and curing agent then triggers a chemical reaction by which the magnetic field-sensitive component is solidified.

According to an expedient embodiment, the particles of the soft magnetic substance are obtained from a strip material.

In particular, metallic glasses are produced by rapid solidification of particularly thin layers of material. In this way, strip material of a soft magnetic substance can be obtained.

In particular, it is proposed that the particles be produced by shredding and/or grinding of a strip material. As a result, the particles of the soft magnetic material can be produced particularly cost-effectively.

It should be expressly noted that the subject matter of the second aspect can advantageously be combined with the subject matter of the preceding aspect of the invention, both individually or cumulatively in any combination.

According to a third aspect of the invention, the object is solved by a magnetic field-sensitive component produced by a method according to the second aspect of the invention.

It is understood that the advantages of a method of producing a magnetic-field sensitive component according to the second aspect of the invention, as described above, extend directly to a magnetic field-sensitive component produced by a method according to the second aspect of the invention.

It should be expressly noted that the subject matter of the third aspect can advantageously be combined with the subject matter of the preceding aspects of the invention, both individually or cumulatively in any combination.

According to a fourth aspect of the invention, the object is achieved by a use of a magnetic field-sensitive component according to the first aspect of the invention and/or according to the third aspect of the invention for an electrical choke.

In this regard, the following is explained conceptually:

A “choke” is understood to mean an inductance, in particular an inductance for limiting, in particular for spectral-physical limiting, currents in an electrical line, for temporarily storing energy in the form of its magnetic field, for impedance matching and/or for filtering.

It is understood that the advantages of a magnetic field-sensitive component according to the first aspect of the invention and/or according to the third aspect of the invention, as described above, extend directly to a use of the magnetic field-sensitive component according to the first aspect of the invention and/or according to the third aspect of the invention.

It should be expressly noted that the subject matter of the fourth aspect is advantageously combinable with the subject matter of the preceding aspect of the invention, both individually or cumulatively in any combination.

Further advantages, details and features of the invention can be found below in the described embodiments. The figures schematically show the following, in detail:

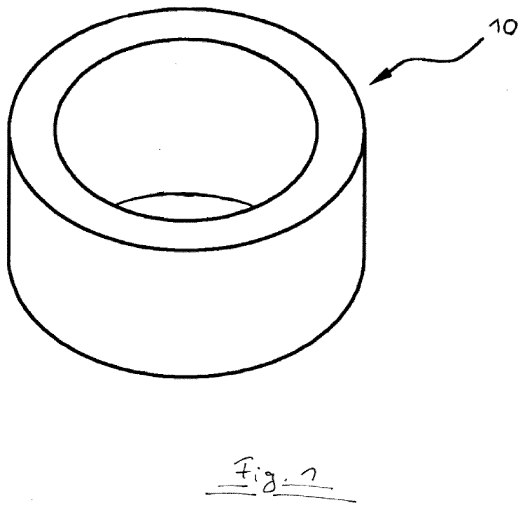

FIG. 1: schematically a magnetic field-sensitive component.

In the following description, the same reference signs denote the same components or features; in the interest of avoiding repetition, a description of a component made with reference to one drawing also applies to the other drawings. Furthermore, individual features that have been described in connection with one embodiment can also be used separately in other embodiments.

The magnetic field-sensitive component 10 in FIG. 1 has particles of a soft magnetic substance.

According to a first embodiment, a powder metallurgical process is used to process the particles of the soft magnetic material into the magnetic field-sensitive component 10, in particular the magnetic field-sensitive component 10 is sintered from the particles of the soft magnetic material under the action of pressure and temperature.

Due to the primary forming of the magnetic field-sensitive component 10 using particles of the soft magnetic substance, it can advantageously be achieved that virtually any forming is possible for the magnetic field-sensitive component 10. This makes it possible to react to the specific boundary conditions, in particular the geometric boundary conditions, of the designated application case with the form of the magnetic field-sensitive component 10.

In particular for application cases in which the thermal stability of the magnetic field-sensitive component 10 plays a dimensioning role, the saturation flux density, the saturation field strength and/or the coercive field strength are dimensioning. The larger the saturation field strength and/or the smaller the coercive field strength and/or the larger the saturation flux density of the magnetic field-sensitive component 10, the smaller the magnetic field-sensitive component 10 can be for maintaining thermal stability.

Due to the selection of material of the particles, the magnetic field-sensitive component 10 has a particularly small coercive field strength and a particularly high saturation induction. The pores between the particles resulting during sintering lead to a reduction in the effective permeability of the magnetic field-sensitive component 10.

According to a second embodiment, the magnetic field-sensitive component 10 also has a matrix material in addition to the particles of the soft magnetic material. Among other things, it should be considered here that the particles are dissolved in the matrix material and that the matrix material is subsequently cured to form a solid magnetic field-sensitive component 10. In particular, a matrix material based on a basic component and a curing agent can be used in this case.

According to a third embodiment, the magnetic-field-sensitive component 10 is produced using a deviating forming method.

According to a fourth embodiment, the magnetic field-sensitive component 10 has an air gap (not shown). With the above-proposed forming methods for the magnetic field-sensitive component 10, an air gap can be produced without the magnetic field-sensitive component 10 having to be machined subsequently. Thereby, the production of a magnetic field-sensitive component 10 with a reduced effective permeability can be greatly simplified.

### LIST OF REFERENCE SIGNS

10 magnetic field-sensitive component

1. A magnetic field-sensitive component, said magnetic field-sensitive component having particles of a soft magnetic material, said magnetic field-sensitive component having a coercive field strength of less than or equal to 10 A/m, preferably of less than or equal to 5 A/m, and particularly preferably of less than or equal to 3 A/m,
wherein
said magnetic field-sensitive component has the particles of the soft magnetic substance in a proportion of greater than or equal to 95% by weight, preferably in a proportion of greater than or equal to 97.5% by weight, and particularly preferably in a proportion of greater than or equal to 99% by weight.

2. The magnetic field-sensitive component according to claim 1, wherein said magnetic field-sensitive component (10) has a remanence of less than or equal to 0.1 T, preferably a remanence of less than or equal to 0.05 T, and particularly preferably a remanence of less than or equal to 0.02 T.

3. (canceled)

4. (canceled)

5. The magnetic field-sensitive component according to claim 1, wherein said magnetic field-sensitive component has a saturation flux density of greater than or equal to 1 T, preferably a saturation flux density of greater than or equal to 1.1 T, and particularly preferably a saturation flux density of greater than or equal to 1.2 T.

6. The magnetic field-sensitive component according to claim 1, wherein the particles have an extension in a range of greater than or equal to 3 μm and less than or equal to 200 μm, preferably an extension in a range of greater than or equal to 4 μm and less than or equal to 100 μm, and particularly preferably an extension in a range of greater than or equal to 5 μm and less than or equal to 50 μm.

7. The magnetic field-sensitive component (10) according to any one of the preceding claims, characterized in that the soft magnetic material has the following atomic composition: 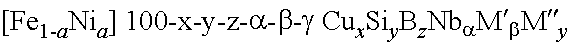
where a≤0.3, 0.6≤x≤1.5, 10≤y≤17, 5≤z≤14, 2≤α≤6, ß≤7, γ≤8, wherein M′ is at least one of the elements V, Cr, Al and Zn, wherein M″ is at least one of the elements C, Ge, P, Ga, Sb, In and Be.

8. (canceled)

9. (canceled)

10. The magnetic field-sensitive component according to claim 1, wherein said magnetic field-sensitive component has a matrix material, in particular a resin-based matrix material.

11. The magnetic field-sensitive component according to claim 1, wherein said magnetic field-sensitive component is sintered.

12. A method for producing a magnetic field-sensitive component according to claim 1 using particles of a soft magnetic material, characterized by the following steps:
forming a blank for said magnetic field-sensitive component using the particles of the soft magnetic material;
tempering and/or curing in order to solidify the blank into said magnetic field-sensitive component; and
demolding said magnetic field-sensitive component.

13. The method according to claim 12, wherein said magnetic field-sensitive component is sintered.

14. The method according to claim 13, wherein the blank is pressed between the forming and the sintering and/or during sintering by applying an external force.

15. The method according to claim 13, wherein said magnetic field-sensitive component is sintered at a temperature in a range of greater than or equal to 400° C. and less than or equal to 650° C., preferably at a temperature in a range of greater than or equal to 450° C. and less than or equal to 620° C., and particularly preferably at a temperature in a range of greater than or equal to 500° C. and less than or equal to 600° C.

16. The method according to claim 13, wherein said magnetic field-sensitive component is sintered over a time range of greater than or equal to 15 seconds and less than or equal to 1,800 seconds, preferably over a time range of greater than or equal to 30 sec and less than or equal to 900 sec, and particularly preferably over a time range of greater than or equal to 45 sec and less than or equal to 600 sec.

17. The method according to claim 12, wherein, in addition to particles of the soft magnetic material, a matrix material is also used to form the blank, in particular a resin-based matrix material.

18. The method according to claim 17, wherein the curing is carried out by a chemical reaction of the matrix material.

19. The method according to claim 12, wherein the particles of the soft magnetic material are obtained from a strip material.

20. (canceled)

21. A use of a magnetic field-sensitive component according to claim 1 for an electrical choke.

22. The magnetic field-sensitive component according to claim 1, wherein the soft magnetic material is a metallic glass.

23. The magnetic field-sensitive component according to claim 22, wherein the soft magnetic material has a nanocrystalline structure.
